(19) United States
(12) Patent Application Publication
(10) Pub. No.: US 2010/0206928 A1
(43) Pub. Date: Aug. 19, 2010

(54) FRONT CARRIER FOR MOTORCYCLES

(75) Inventor: Antonio Bertini, Certaldo (Firenze) (IT)

Correspondence Address: LUCAS & MERCANTI, LLP, 475 PARK AVENUE SOUTH, 15TH FLOOR, NEW YORK, NY, 10016, US

(73) Assignee: OXYGEN, S.P.A., Reggio Emilia (IT)

(21) Appl. No.: 12/671,464

(22) PCT Filed: Aug. 2, 2007
(86) PCT No.: PCT/IT07/00557

§ 371 Date: Apr. 22, 2010

(51) Int. Cl. B62J 9/00

(52) U.S. Cl. 224/413

(57) ABSTRACT

Front carrier for motorcycles, comprising a loading platform (11) connected to the front portion of the chassis (C) of the motorcycle (S) through bracketing means (14). These bracketing means (14) comprise means (23) for adjusting the inclination of the platform (11) by rotation about an axis (X) substantially parallel to the axis of the front wheel of the motorcycle.

### FIELD OF THE INVENTION

The present invention relates to the field of accessories for scooters and motorcycles in general, and more particularly concerns a carrier to be arranged at the front part of a scooter.

### STATE OF THE ART

As known, when there is a need to use a scooter to transport objects and goods, it is normal to equip the vehicle with rear and/or front carriers.

As far as front carriers are concerned, they generally comprise a loading platform rigidly fixed cantilevered to the chassis portion relative to the front shield of the scooter through a bracket. Side-boards for containing the loads are associated with the platform.

The carrier is an accessory generally designed ad hoc for the model or family of scooters which it must be associated with. The position of the platform with respect to the chassis of the scooter is a design requirement that substantially cannot be modified.

In common practice, however, carriers for scooters intended to transport loads have different functional requirements according to the type and amount of load which they are subjected to. For example, the load relative to a scooter intended to transport food for home delivery is generally much different in weight and volume compared to the load relative to a scooter intended for postal delivery.

With particular reference to carriers to be fixed to the front part of the scooter, special functional requirements are linked to two important aspects: a) the stability of the load, in particular while the vehicle is braking, b) the accessibility of the load to the driver of the vehicle.

It is clear, given the fact that the carrier-scooter mounting cannot be modified with respect to a given design configuration, how such aspects cannot be optimal for all uses of the carrier, but only for those for which the carrier was possibly designed ad hoc.

It may, for example, be the case that a front carrier is designed to be fixed to the scooter in the lowest possible position to ensure a barycentre close to the ground, a thing that is particularly useful in the case of normally heavy loads. In this way, however, the driver's ability to access the load from the driving position is jeopardised. Vice-versa, if the carrier is designed to be fixed in a position close to the steering handlebars, there is optimal access to the load but the disposition of the masses is not satisfactory.

The object of the present invention is therefore to provide a front carrier for scooters or motorcycles in general, which can allow adaptation to different types of load to be transported.

Referring to this object, another important object of the present invention is to provide a front carrier for scooters that ensure optimal stability of the load, particularly while the vehicle is braking.

A further important object of the invention is to provide a front carrier for scooters that allows the driver of the vehicle to have optimal access to the load.

### SUMMARY OF THE INVENTION

These objects are achieved with a front carrier for motorcycles, comprising a loading platform connected to the front portion of the chassis of the motorcycle through bracketing means, characterised in that said bracketing means comprise means for adjusting the inclination of said platform by rotation about an axis substantially parallel to the axis of the front wheel of the motorcycle.

### BRIEF DESCRIPTION OF THE DRAWINGS

Further characteristics and advantages of the front carrier for motorcycles according to the present invention will be made apparent from the following description of an embodiment thereof, made as a non-limiting example with reference to the appended drawings wherein:

FIG. 1 shows an axonometric view of a front portion of a motorcycle, namely a scooter, without the shell of the front shield, showing a carrier according to the invention;

FIG. 2 shows a side view of the same carrier of FIG. 1;

FIG. 3 shows an axonometric view of a front portion of the scooter of the previous figures (the shield being omitted for the sake of clarity), partially showing the bracketing means of the carrier according to the invention.

### DETAILED DESCRIPTION OF THE INVENTION

With reference to the above figures, a carrier according to the invention comprises a loading platform 11 connected to the front portion of the chassis C of a scooter S through bracketing means 12.

The loading platform 11 comprises a grid formed by a tubular perimetric frame 13a, longitudinal beams 13b arranged inside the shape of the perimetric frame 13a, and tubular boards 13c that extend on four sides of the perimetric frame.

The bracketing means 12 comprise a stirrup 14 consisting of two metallic bars 15 with rectangular section. Said bars 15 are fixed vertically, parallel to one another, through bolts, on supports 16 and 17 for firm connection to the chassis of the scooter S. In particular there is an upper support 16 positioned at the high part of the shield of the scooter, and two lower supports 17 fixed at the low part of the shield. Said lower supports 17 consist of metallic plates fixed to the chassis of the scooter through bolts. In particular, the two lower supports 17 have two corresponding overlapping flat parts 17a fixed to the chassis of the scooter and two opposite parts 17b diverging apart, fixed, flat side on flat side, to the two bars 15.

The bracketing means 12 also comprise a bracket body 18 fixed by an end part to the bars 15. The fixing system of the bracket body 18 comprises four dedicated bolts 19 (two for each bar) arranged through corresponding through holes 15a formed in the bars 15. Along the two bars 15 there is a plurality of said holes 15a for height-adjusting the bracket body 18 during the assembling of the carrier to the scooter. The loading platform 11 is supported by the bracket body 18, as is explained more clearly hereafter.

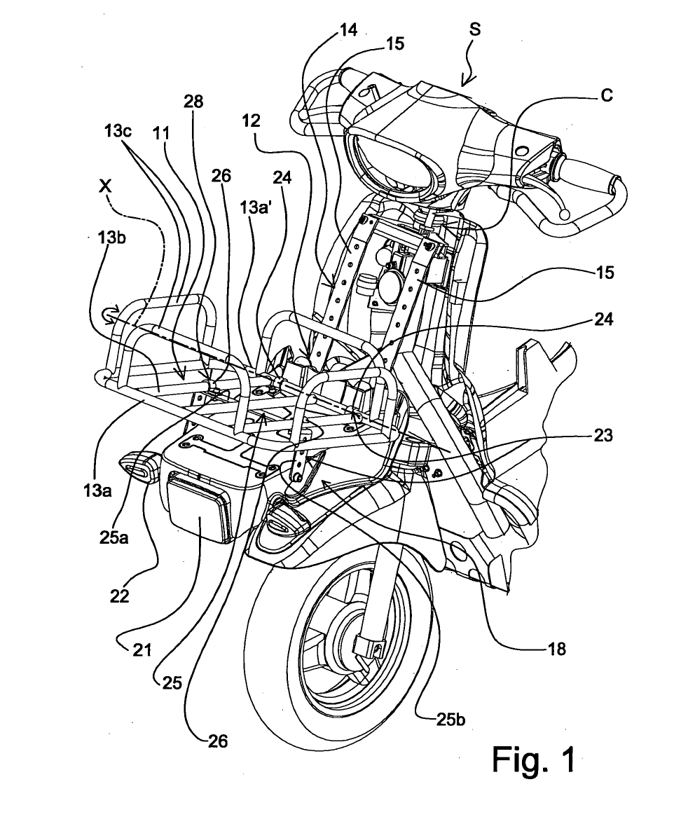

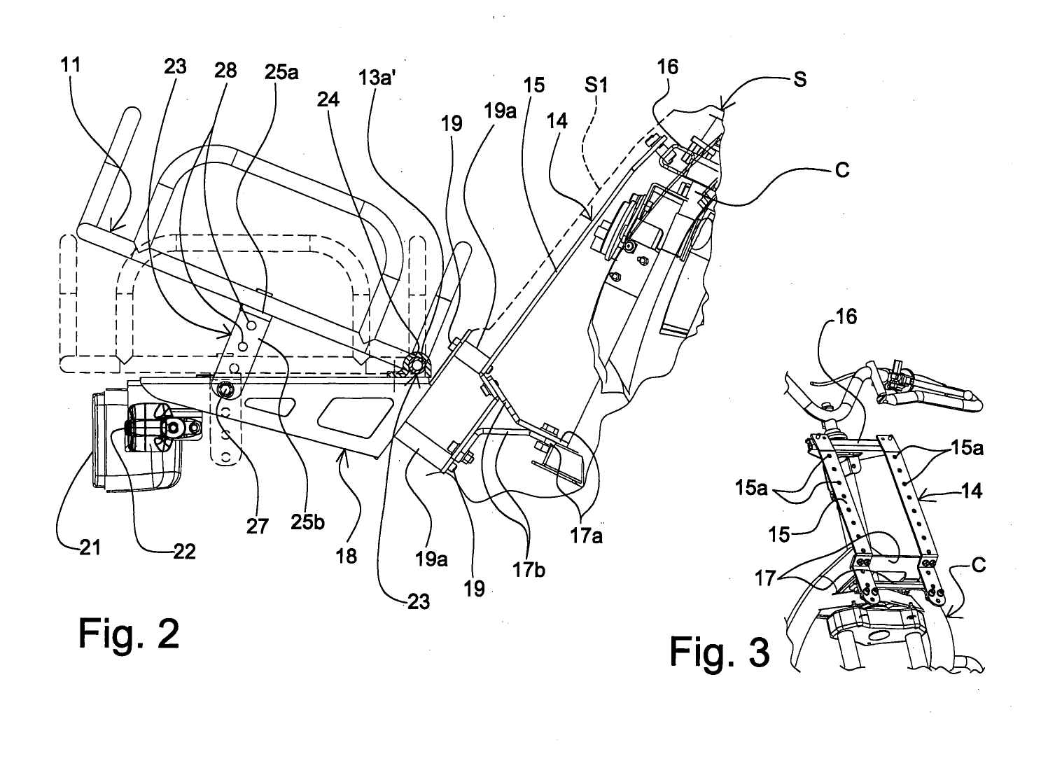

Each dedicated bolt 19 is provided with a spacing bush 19a arranged between the bracket body and the bars. This spacing bush 19a allows the bracket body 18 to be arranged outside of the shell of the shield S1 (schematically indicated with a broken line in FIG. 2) of the scooter S. The bracket body 18 is covered on the outside by a covering case 20 (shown in FIG. 1, not shown in FIG. 2).

At the free end of the bracket body 18 there is the headlight 21 of the scooter and the two indicators 22, connected through suitable electric cables (not shown in the figures) to the electronic box of the scooter and to the power supply (also not shown in the figures).

According to the invention, the bracketing means 12 also comprise means 23 for adjusting the inclination of the loading platform 11 by rotation about an axis X substantially parallel to the axis of the front wheel of the scooter.

According to a preferred embodiment of the invention, said adjustment means 23 comprise a hinge for connecting the rear segment 13a′ of the perimetric frame 13a of the loading platform 11 to the bracket body 18. Said hinge consists, for example, of a pair of substantially C-shaped plates 24 firmly connected through screws to the upper plane pf the bracket body 18. The concavity of said plates 24 faces towards the bracket body to define a rotational seat for the rear segment 13a′ of the perimetric frame of the platform 11, which has a circular section. Said hinge is located close to the end of the bracket body nearby the shell S1 of the shield of the scooter.

The adjustment means 23 also comprise a device for locking the rotation of the platform about the hinge axis X in an adjustable angular position. In this embodiment, said locking device comprises a U-shaped body 25 pivoted to the opposite lateral sides of the bracket body 18. Such a U-shaped body 25 consists of a flat central portion 25a, on which the loading platform 11 rests, and two side flanges 25b pivoted coaxially to the opposite lateral sides of the bracket body 18. Two substantially C-shaped metallic rods 26 are fixed in the central portion 25a through bolts. The concave parts of the rods 26 lock respective longitudinal beams 13b against the central portion 25a.

The connection of the side flanges 25b to the lateral sides of the bracket body 18 is carried out via two opposite threaded pivots 27 respectively inserted into corresponding housings defined on the bracket body 18 and in corresponding seats 28 defined on the side flanges 25b. Aligned along each flange 25b there is a plurality of said seats 28 (e.g. through holes) for the pivots 27.

To vary the inclination of the loading platform 11 it is sufficient to displace both pivots 27 in the appropriate seats 28. At the same time, it is necessary to loosen the clamping action of the rods 26 on the central portion 25a to allow a translation of the U-shaped body 25 along the longitudinal beams 13b into a new geometrically congruent position.

It is clear that the invention as described achieves the proposed objects he set purposes. The inclination adjustment of the loading platform allows to adjust the height of the load, optimising its position according to its weight and type. For example, if it is necessary to have the load arranged closest to the driver of the scooter, it is possible to incline the platform upwards by the desired angle, making it easier for the driver to reach the load. The inclination of the platform by lifting the front part makes it possible to reduce the forward-lean effect of the load during braking, thus improving the overall stability of the motorcycle. These adjustments can be carried out by the user himself even after the assembly of the carrier to the motorcycle.

The particular structure of the bracket for connection to the frame of the motorcycle allows to choose, during the assembly of the motorcycle itself, the most suitable position in height for the loading platform in relation to the probable use of the vehicle. Furthermore, the particular structure of the bracket allows to support heavy loads.

Variants and/or changes may be made to the carrier according to the present invention without departing from the scope of the invention as set forth in the following claims.

Where any of the characteristics and techniques described in any of the claims are followed by reference signs, these have been included for the purpose of providing examples simply to increase the clarity of the claims and consequently, they have no limiting effect on the interpretation of each element they identify.

1-8. (canceled)

9. Front carrier for motorcycles, comprising a loading platform connected to the front portion of the chassis of a motorcycle through bracketing means, said bracketing means comprising means for adjusting the inclination of said platform by rotation about an axis substantially parallel to the axis of the front wheel of the motorcycle, wherein said bracketing means also comprises a bracket body fixed cantilevered to said chassis of the motorcycle, said bracket body being fixed by an end part thereof to bars, said bars comprising a plurality of holes for height-adjusting the bracket body during the assembling of the front carrier to the motorcycle.

10. Front carrier for motorcycles according to claim 1, wherein said means for adjusting the inclination of said platform comprises a hinge for connecting the rear area of said loading platform to said bracket body, said hinge being located close to the end of said bracket body nearby the chassis, said adjustment means also comprising a device for locking the rotation of said platform about the hinge axis in an adjustable angular position.

11. Front carrier for motorcycles according to claim 2, wherein said hinge for connecting the rear area of said loading platform comprises at least one substantially C-shaped plate fixed through threaded elements to the upper plane of said bracket body, the concavity of said C-shaped plate facing towards said bracket body to define a rotational seat for the rear segment of the peripheral frame that defines said platform, said rear segment having a circular section.

12. Front carrier for motorcycles according to claim 2, wherein said device for locking the rotation of said platform about said hinge axis in an adjustable angular position comprises at least one flange reversibly connected by one end, through locking means, to said loading platform and pivoted to said bracket body through a corresponding pivot parallel to said axis, said pivot being coupled with a seat selected from a plurality of seats defined along the extension of said flange.

13. Front carrier for motorcycles according to claim 4, wherein said device for locking the rotation of said platform about said hinge axis in an adjustable angular position comprises a U-shaped body consisting of a central portion on which said loading platform rests, at the ends of which there are two of said side flanges pivoted coaxially to the opposite lateral sides of the bracket body, said locking means being present on said central portion.

14. Front carrier for motorcycles according to claim 4, wherein said platform comprises a grid formed by a peripheral frame and longitudinal beams arranged inside the peripheral frame, said locking means comprising at least one substantially C-shaped metallic rod fixed through threaded elements on said central portion, said metallic rod locking, with the concave part, a respective said longitudinal beam against the same central portion.

15. Front carrier for motorcycles according to claim 6, wherein said bracketing means comprises a stirrup consisting of at least two metallic bars fixed substantially vertically on three supports for firm connection to the chassis of the motorcycle, said plurality of holes being provided along said two metallic bars for the attachment, through threaded elements, to said bracket body.

16. Front carrier for motorcycles according to claim 7, wherein said supports respectively comprise an upper support and two lower supports consisting of metallic plates fixed to the frame through threaded elements, said two lower supports having two corresponding overlapping flat parts fixed to the chassis of the motorcycle and two opposite parts diverging apart, fixed, flat side on flat side, to said two bars.
